(19) United States
(12) Patent Application Publication
(10) Pub. No.: US 2015/0284638 A1
(43) Pub. Date: Oct. 8, 2015

(54) FIREPROOF COMPOSITION AND FIREPROOF THERMAL INSULATION BOARD

(71) Applicant: ASIA CUANON TECHNOLOGY (SHANGHAI) CO., LTD, Shanghai (CN)

(72) Inventors: Zhixin Xu, Qingpu Zone (CN); Gang Shen, Qingpu Zone Shanghai (CN); Jinzhong Li, Qingpu Zone Shanghai (CN)

(73) Assignee: ASIA CUANON TECHNOLOGY (SHANGHAI) CO., LTD., Qingpu District, Shanghai (CN)

(21) Appl. No.: 14/439,632

(22) PCT Filed: Apr. 12, 2013
(86) PCT No.: PCT/CN2013/074131

§ 371 Date: Apr. 29, 2015

(30) Foreign Application Priority Data
Oct. 30, 2012 (CN) 201210425707.8

(51) Int. Cl. C09K 21/14; B32B 9/04; B32B 15/04; B32B 5/18; E04B 1/80

(52) U.S. Cl. CPC C09K 21/14; B32B 5/18; E04B 1/80; B32B 15/046; B32B 9/046; B32B 2307/3065; B32B 2307/304; B32B 2266/0214; B32B 2419/00

(57) ABSTRACT

Disclosed are a fireproof composition and a fireproof thermal insulation board containing the fireproof composition. The fireproof composition comprises by weight: a thermosetting resin of 30-65 parts, an inorganic flame retardant of 15-45 parts, a flame retardant structure reinforcer of 2-25 parts, a solvent of 5-15 parts and a curing agent of 2-6 parts, wherein the curing agent is separately packaged and is added before use. The fireproof thermal insulation board comprises foamed plastic particles and the fireproof composition bonding with the foamed plastic particles. The fireproof thermal insulation board has thermal insulation features, prevents burning at high temperature and collapse at high temperature, and reduces poisonous black smoke.

This application is a US National Stage of International Application No. PCT/CN2013/074131, filed on Apr. 12, 2013, designating the United States and claiming priority to Chinese Patent Application No. 201210425707.8, filed on Oct. 30, 2012, which is hereby incorporated by reference in its entirety.

### FIELD

The present invention relates to a fireproof composition and a fireproof heat-preservation board and particularly to a composition, with fireproof function and direct brushing, including organic and inorganic components, and a fireproof heat-preservation board including the fireproof composition.

### BACKGROUND

The number of houses built annually in China currently at the peak of building has been up to 2 to 3 billions of square meters, which exceed the total area of houses built annually in all the developed countries. More than 80% of buildings are highly energy-consuming buildings which consume more than 40% of the total energy consumption in the world as the leading one of various energy consumers. Thus energy saving of buildings has become one of predominate energy-saving trends in the world, and energy saving technologies of buildings have become an important aspect of the current development of building technologies in the world. Required indexes of energy saving of houses have also been ascertained in the National Twelfth Five-Year Plan Guideline in order to facilitate healthy development of energy saving of buildings and the building industry.

Energy saving of buildings relates to an important aspect which is heat preservation of walls of the buildings. At present, heat-preservation materials for walls of buildings in China generally include Expandable Poly-Styrene (EPS) boards, Extrudable Poly-Styrene (XPS) boards, Polyurethane boards, Polystyrene boards, inorganic heat-preservation boards, etc., where the predominate EPS boards, XPS boards and Polyurethane boards account for more than 80% of the total amount of heat-preservation materials for outdoor walls. Both the EPS boards and the XPS boards are essentially Polystyrene boards because general components of both of them are Polystyrene; and both the EPS boards and the XPS boards are thermoplastic organic foam boards. These heat-preservation materials are applied to buildings for effective heat preservation in energy saving of the buildings, but these heat-preservation boards suffer from the drawback of their poor fireproofing so that there may be such a significant hidden risk for fireproofing of the buildings that fires might occur frequently and result in a great loss.

In a large number of fires of the buildings, poor fireproofing of the heat-preservation materials, and poisonous smokes released from the burning materials are major causes of serious casualties, and also after the outdoor walls of the builds take fire, the surfaces of the outdoor walls burns so that the heat-preservation materials collapse in structure, so coatings and decorated layers on the surfaces of the walls of the buildings fall down, and there are absent working surfaces for fire fighting and rescuing, thus making it very inconvenient for fire fighting and rescuing, and this is also a cause of the serious casualties. In view of this, (Temporary Provisions of fireproofing of external heat-preservation system and exterior wall decoration of civil buildings)) [Public Notification Document, No. 46] has been issued by the Ministry of Public Security and the Ministry of Hosing and Urban-Rural Development in 2009, and (Notice for further determining management requirement for fireproofing of external heat-preservation materials of civil buildings)) [Public fire protecting document, No. 65] has been issued by the Ministry of Public Security in 2011, for the purpose of enhancing required fireproofing of heat-preservation materials of buildings. Furthermore it has been specified in [Public fire protecting document, No. 65] that “heat-preservation materials of buildings are heat-preservation materials with A-level fireproofing before a new standard is issued”. However none of the A-level heat-preservation materials in the market at present is suitable for heat preservation of walls of buildings from the technical perspective of their products because the existing A-level heat-preservation materials are generally inorganic materials or their primary components are inorganic materials, so they may suffer from high weights, low strengths and poor heat preservation so that they may not be easy to apply and their energy saving effects may not be satisfactory; and moreover the yield of the existing A-level heat-preservation materials may not satisfy the market demand so that a large number of building projects have been halted. Thus the study and the research and development of A-level heat-preservation materials satisfactory for heat preservation of outdoor walls have earned common attention in the industry.

As well known, the inorganic materials are non-combustible materials to effectively suppress frames from spreading, so the inorganic materials, e.g., rock wools, etc., are preferred as alternatives to the heat-preservation and heat-insulation materials above, but these alternative materials either have an unsatisfactory heat preservation and heat insulation effect or are highly brittle and insufficiently strong or have so high weights that they are not suitable for high buildings. There have been absent so far ideal heat-preservation materials with an addressed tradeoff between the combustibility and the heat-preservation and heat-insulation. Moreover silicate concrete or sodium chlorides and magnesia are used as primary bonding materials to which EPS granules are added, thus resulting in heat-preservation materials (glue powder polystyrene granular mortar). However the heat-preservation materials for buildings produced this way may suffer from a poor heat-preservation effect, low strength, a high weight of the materials (a high specific gravity thereof), loose setting, poor operability in construction, etc., despite of their good fireproofing.

Moreover in order for fireproofing in the field of fireproofing at present, an incombustible material is generally looked for, e.g., a fireproof rolling curtain typically made of glass fibers together with non-woven fabrics. There has been absent so far a coating-like product applied to the surface of an object to be fireproofed for the purpose of fireproofing. A fireproof composition according to this application can be applied directly to surfaces of various products or sites to be fireproofed so that it can be applied to other fireproof products and other situations where fireproofing is required, for the purpose of fireproofing to thereby greatly improve the fireproofing solution.

Thus the inventors of this application have identified from their long-term researches and experiments that organic and inorganic components are integrated instead into the fireproof composition and the fireproof heat-preservation board according to this application so that fireproofing and strength thereof can be greatly improved while maintaining the advantages of excellent heat-preservation and low weights of the traditional EPS boards, XPS boards, Polyurethane boards, Polystyrene boards and other heat-preservation boards of buildings to thereby effectively address the respective problems of the existing heat-preservation materials for buildings.

### SUMMARY

In order to address at least one of the problems of poor fireproofing of heat-preservation materials for buildings, poisonous smokes released from the burning materials, low strength thereof, easy melting and dropping of the burning materials, etc., in the prior art, embodiments of the invention provide a fireproof composition, and a heat-preservation board including the fireproof composition so as to effectively address the problems above in the prior art.

In view of this, an embodiment of the invention provides a fireproof composition including the following components:

30 to 65 parts a thermosetting resin in;

15 to 45 parts of an inorganic fire retardant;

2 to 25 parts of a fire retarding structure enhancer;

5 to 15 parts of a solvent; and

2 to 6 parts of a curing agent,

wherein the curing agent is packaged separately for adding in use.

Furthermore the fireproof composition further includes: 1 to 5 parts by weight of reinforcing fiber.

Still furthermore the fireproof composition further includes: 0.2 to 2 parts by weight of a dispersant and a surfactant.

Preferably the thermosetting resin includes a Polyacrylic acid resin, a Poly (ethylene carbonate) resin, a Polyurethane resin, a Polyvinyl acetate resin or a Phenolic resin

Furthermore the Phenolic resin is an A-stage Phenolic resin as a result of condensation reaction between phenol and Paraformaldehyde under an alkali catalyst, wherein the phenol, the Paraformaldehyde and the alkali catalyst are proportioned as 40 to 60 parts by weight of the phenol, 30 to 45 parts by weight of the Paraformaldehyde, and 1.5 to 8.0 parts by weight of the alkali catalyst together with 5 to 15 parts by weight of water, all of which react with each other for five hours at 70 to 80° C. into the A-stage Phenolic resin.

Preferably the inorganic fire retardant includes any one or combination of magnesium hydroxide, aluminum hydroxide, Carbon black, red phosphorus fire-retardant and ammonium polyphosphate.

Preferably the fire retarding structure enhancer includes any one or combination of lithium carbonate, lepidolite, boracic acid and borax.

Preferably the solvent is water, methanol or ethanol.

Preferably the curing agent is phenol sulfonic acid or toluene sulfonic acid.

Preferably the reinforcing fiber includes any one or combination of glass fiber, carbon fiber and metal fiber.

Preferably the dispersant and the surfactant include a mixture of modified Polysiloxane and polymeric Carboxylic acid.

Preferably the thermosetting resin includes a Polyacrylic acid resin, a Poly (ethylene carbonate) resin, a Polyurethane resin, a Polyvinyl acetate resin or a Phenolic resin; the inorganic fire retardant includes any one or combination of magnesium hydroxide, aluminum hydroxide, Carbon black, red phosphorus fire-retardant and ammonium polyphosphate; the fire retarding structure enhancer includes any one or combination of lithium carbonate, lepidolite, boracic acid and borax; the solvent is water, methanol or ethanol; the curing agent is phenol sulfonic acid or toluene sulfonic acid; the reinforcing fiber includes any one or combination of glass fiber, carbon fiber and metal fiber; and the dispersant and the surfactant include a mixture of modified Polysiloxane and polymeric Carboxylic acid.

The fireproof composition above according to the embodiment of the invention includes the organic thermosetting resin and the inorganic fire retardant added thereto, and when the composition takes fire, the thermosetting resin therein is heated and carbonized while maintaining the inherent structure, and the inorganic fire retardant therein suppresses the component from burning for the purpose of fireproofing and also suppresses smokes from being emitted, to thereby prevent the smokes from occurring; and also with the fire retarding structure enhancer added thereto, the resin, the inorganic fire retardant and the fire retarding structure enhancer are integrated into the inorganic glass structural fire retardant to isolate flames and heat for the purpose of fireproofing; and moreover the added solvent can adjust the viscosity and the fluidity of the resin to thereby facilitate applying of the fireproof composition; and the curing agent can be added in use to thereby facilitate rapid coagulation of the fireproof composition and bonding thereof to the object to which the fireproof composition is applied. Moreover the reinforcing fibers can be further added as desirable to thereby improve the strength of the fireproof composition and the strength of the residuals after the coating is fired; and furthermore the dispersant and the surfactant can be added to thereby facilitate better bonding together of the fireproof composition to the object to which the fireproof composition is applied.

Moreover the fireproof composition according to the embodiment of the invention can be further applicable to various other objects and scenarios for which fireproofing is required, for example, it can be applied to the surface of a wooden furniture to thereby improve the fireproofing level of the furniture; and it can be applied to the surface of a fireproof rolling curtain to thereby enhance the fireproofing function of the fireproof rolling curtain, so it can be widely applied.

An embodiment of the invention provides a fireproof heat-preservation board including foam plastic granules, and a fireproof coating for bonding the foam plastic granules, wherein the fireproof coating is the fireproof composition according to any one of the technical solutions above.

In the technical solution above, preferably the fireproof coating is arranged consecutively in the fireproof heat-preservation board, and the foam plastic granules are dispersed in the fireproof heat-preservation board.

In the technical solution above, preferably a volume-weight of the foam plastic granules is 10 to 25 kg/m³, and a weight proportion of the foam plastic granules to the fireproof coating is: the foam plastic granules to the fireproof coating=1: (0.8 to 5)

In any one of the technical solutions above, preferably the foam plastic granules include Polystyrene, Polyethylene, Polypropylene, Polyurethane or Polyvinylchloride granules.

In the technical solution above, preferably a top plate is compounded on one board surface of the fireproof heat-preservation board.

In the technical solution above, preferably a bottom plate is compounded on another board surface of the heat-preservation board.

In the technical solution above, preferably the top plate and/or the bottom plate are compounded through adhesives.

In the technical solution above, preferably the top plate is a color steel plate, a Calcium silicate plate, a cement fiber plate, an aluminum foil, a fiber cement cloth or a stone plate; and the bottom plate is a color steel plate, a Calcium silicate plate, a cement fiber plate, an aluminum foil, a fiber cement cloth or a stone plate.

The fireproof heat-preservation board above according to the embodiment of the invention includes the dispersed foam plastic granules which serve as a framework, and the consecutive fireproof coating for protecting to thereby effectively prevent burning and collapsing at high temperature and greatly suppress poisonous smokes from being emitted. The fireproof composition which is used as the fireproof coating in the fireproof heat-preservation board according to the embodiment of the invention includes the organic thermosetting resin and the inorganic fire retardant added thereto, and when the composition takes fire, the thermosetting resin therein is heated and cured, the structure of the heat-preservation board is maintained without collapsing in structure, and the inorganic fire retardant is non-combustible for the purpose of fireproofing; and also with the fire retarding structure enhancer added thereto, the resin, the inorganic fire retardant and the fire retarding structure enhancer are integrated at temperature into the inorganic glass structural fire retardant to isolate flames and heat for the purpose of fireproofing so that the organic foam plastic granules are not burned and will not emit poisonous black smokes so as to address the numerous drawbacks of the existing heat-preservation boards of buildings and satisfy the required level and heat preservation for the heat-preservation boards of buildings. Moreover the top plate and/or the bottom plate can be further compounded on the fireproof heat-preservation board to thereby further improve the fireproofing and the strength of the fireproof heat-preservation board.

### BRIEF DESCRIPTION OF THE DRAWINGS

FIG. 1 illustrates a schematic three-dimension structural diagram of a fireproof heat-preservation board according to an embodiment of the invention;

FIG. 2 illustrates a schematic structural diagram of a enlarged partial section of the embodiment illustrated in FIG. 1;

FIG. 3 illustrates a schematic three-dimension structural diagram of a fireproof heat-preservation board according to another embodiment of the invention; and

FIG. 4 illustrates a schematic three-dimension structural diagram of a fireproof heat-preservation board according to still another embodiment of the invention.

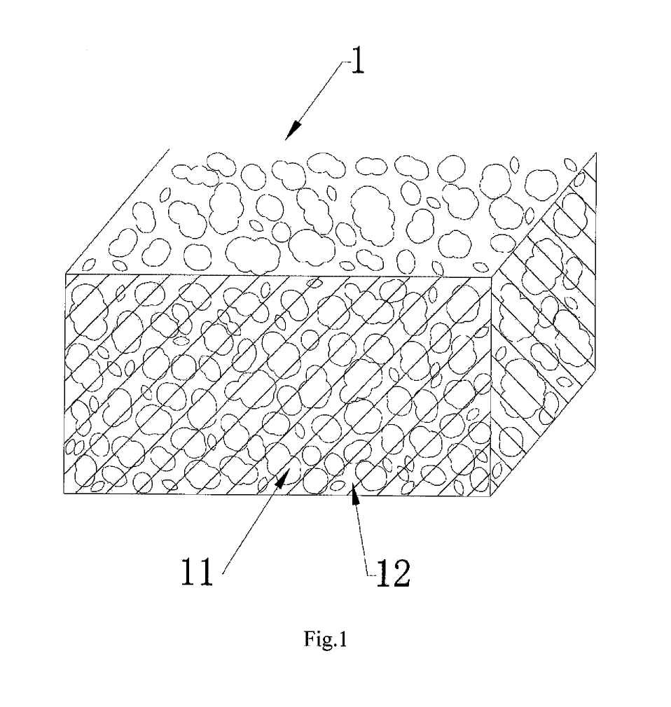

Reference numerals correspond to denominated components in FIG. 1 to FIG. 4 as follows:

1—Fireproof heat-preservation board, 11—Foam plasmatic granule, 12—Fireproof coating, 2—Top plate, 3—Bottom board

### DETAILED DESCRIPTION OF THE EMBODIMENTS

Particular embodiments of the invention will be described below with reference to the drawings.

Numerous details will be set forth below to make the invention more apparent, but the invention can also be embodied in numerous other implementations than those described here, so the scope of the invention as claimed will not be limited to the particular embodiments disclosed below.

A fireproof composition according to an embodiment of the invention includes the following components:

From 30 to 65 parts by weight of a thermosetting resin;

From 15 to 45 parts by weight of an inorganic fire retardant;

From 2 to 25 parts by weight of a fire retarding structure enhancer;

From 5 to 15 parts by weight of a solvent; and

From 2 to 6 parts by weight of a curing agent,

Where the curing agent is packaged separately for adding in use.

The term “by weight” referred to in this application is a weight percentage, so the 30 to 65 parts by weight means a weight percentage of 30 to 65%.

The fireproof composition above according to the invention includes a base which is the thermosetting resin to which the inorganic fire retardant and the fire retarding structure enhancer are added and well blended with the solvent and then packaged, and the curing agent in the specific content is further added thereto in use and stirred for uniformity so that the fireproof composition can be applied or coated to the surface of an object to be fireproofed for the purpose of fireproofing.

Furthermore 1 to 5 parts by weight of reinforcing fibers can be added to the fireproof composition above, so that the strength of the fireproof composition above can be improved and a fireproof layer with a desirable thickness can be formed on the surface of the object to which the fireproof composition is applied or coated.

Still furthermore 0.2 to 2 parts by weight of a dispersant and a surfactant can be added to the fireproof composition above so that the fireproof composition can be dispersed to thereby improve the surface characteristic of the fireproof composition for its firmer contact and bonding with the object to which the fireproof composition is applied or coated.

The dispersant, the surfactant and the reinforcing fibers can be added to the fireproof composition together or separately as needed.

In the fireproof composition above, the thermosetting resin is a Polyacrylic acid resin, a Poly (ethylene carbonate) resin, a Polyurethane resin, a Polyvinyl acetate resin or a Phenolic resin.

Preferably the thermosetting resin is the Phenolic resin which is an A-stage Phenolic resin as a result of condensation reaction between phenol and Paraformaldehyde under an alkali catalyst, where the phenol, the Paraformaldehyde and the alkali catalyst are proportioned as 40 to 60 parts by weight of the phenol, 30 to 45 parts by weight of the Paraformaldehyde, and 1.5 to 8.0 parts by weight of the alkali catalyst together with 5 to 15 parts by weight of water, all of which react with each other for five hours at 70 to 80 □ into the A-stage Phenolic resin.

The thermosetting resin can be embodied in a number of ways as long as it is a resin which can be carbonized upon taking fire, and as demonstrated from a number of experiments by the applicants, the Phenolic resin provides the best effect so that the A-stage Phenolic resin above can be preferred to make full use of the fireproof function of the fireproof composition according to the embodiment of the invention, and the Phenolic resin is friendly to the environment in that no poisonous substances will result from the burning such material, so it is a preferred resin.

Preferably the inorganic fire retardant is any one or combination of magnesium hydroxide, aluminum hydroxide, Carbon black and red phosphorus fire-retardant. The magnesium hydroxide and the aluminum hydroxide are non-combustible inorganic materials, and water will result from chemical reaction thereof upon being heated at high temperature (that is, crystal water will be released) to suppress smokes from being emitted, so as to improve the fire retarding effect; and the Carbon black and the red phosphorus will be carbonized rapidly upon being heated at high temperature to suppress oxygen in the air from entering so as to further suppress burning.

Preferably the fire retarding structure enhancer is any one or combination of lithium carbonate, lepidolite, boracic acid and borax. The resin, the inorganic fire retardant and the fire retarding structure enhancer are integrated at high temperature into an inorganic glass structural fire retardant to isolate flames and heat so as to further suppress oxygen in the air from entering to thereby prevent reaction at temperature for the purpose of fireproofing.

Preferably the solvent is water, methanol or ethanol. The solvent can be selected so that the thermosetting resin is solved therein and the fireproof composition has suitable fluidity and is easily vaporized, after being applied, to thereby adjust the viscosity and the fluidity of the fireproof composition.

Preferably the curing agent is phenol sulfonic acid or toluene sulfonic acid so that the fireproof composition can be coagulated rapidly after being applied on the object. Since the curing agent functions only when the fireproof composition is applied, the curing agent will be added and blended uniformly before the fireproof composition is applied.

Preferably the reinforcing fibers are any one or combination of glass fibers, carbon fibers and metal fibers. The reinforcing fibers here can be selected from short glass fibers, carbon fibers or metal fibers, and they can be added to the fireproof composition to improve the strength of the fireproof composition. Since these fibers themselves are non-combustible materials, they can further suppress the fireproof composition from shrinking and deforming and improve the strength of residuals of the fired coating.

Preferably the dispersant and the surfactant are a mixture of modified Polysiloxane and polymeric Carboxylic acid, e.g., BYK 104S or BYK 904S available in the market. The dispersant and the surfactant can be added so that the fireproof composition is dispersed and has affinity to thereby facilitate better bonding of the fireproof composition to the object to which the fireproof composition is applied.

Preferably Polyacrylic acid resin, Poly (ethylene carbonate) resin, the Polyurethane resin, Polyvinyl acetate resin or Phenolic resin; any one or combination of magnesium hydroxide, aluminum hydroxide, Carbon black, red phosphorus fire-retardant and ammonium polyphosphate; any one or combination of lithium carbonate, lepidolite, boracic acid and borax; water, methanol or ethanol; phenol sulfonic acid or toluene sulfonic acid; any one or combination of glass fibers, carbon fibers or metal fibers; and modified Polysiloxane or polymeric Carboxylic acid are added to the fireproof composition as components thereof.

The embodiment of the invention provides the fireproof composition, in which the inorganic fire retardant is added to the organic thermosetting resin. When the composition takes fire, the thermosetting resin therein is heated and carbonized while maintaining the inherent structure, and the inorganic fire retardant therein suppresses the composition from burning for the purpose of fireproofing and also suppresses smokes from being emitted to thereby prevent the smokes from occurring. Also the fire retarding structure enhancer added thereto, the resin, the inorganic fire retardant and the fire retarding structure enhancer are integrated into the inorganic glass structural fire retardant to isolate flames and heat for the purpose of fireproofing. Moreover the added solvent can adjust the viscosity and the fluidity of the resin to thereby facilitate applying of the fireproof composition; and the curing agent can be added in use to thereby facilitate rapid coagulation of the fireproof composition and bonding thereof to the object to which the fireproof composition is applied. Moreover the reinforcing fibers can be further added as desirable to thereby improve the strength of the fireproof composition and the strength of the residuals after the coating is fired; and furthermore the dispersant and the surfactant can be added to thereby facilitate better bonding together of the fireproof composition to the object to which the fireproof composition is applied.

The invention will be further described below in connection with embodiments thereof where particular contents of the respective components are given.

### First Embodiment

The fireproof composition was fabricated experimentally by the following raw materials, and fireproofing thereof was tested:

47 parts of A-stage Phenolic resin,

31 parts of magnesium hydroxide,

8.5 parts of Borax,

8.5 parts of Methanol,

1.7 parts of Carbon fiber, and

0.8 part of BYK 104S.

A precursor of the fireproof composition was fabricated through dispersion, and then 2.5 parts of Phenol sulfonic acid was mixed therewith uniformly to coat foam granules in an Expandable Poly-Styrene (EPS) heat-preservation board (an EPS board). The EPS board coated with the fireproof composition was burned in an experiment and showed good fireproofing: there were no poisonous black smokes emitted, no collapsing at high temperature and no droplets. Compared with the EPS board in the prior art, the fireproofing of the EPS board was significantly improved up to B1-level fireproofing. Fireproofing of the fireproof composition according to the invention was demonstrated.

### Second Embodiment

The fireproof composition was fabricated experimentally with the following raw materials, and fireproofing thereof was tested:

43 parts of A-stage Phenolic resin,

33 parts of Aluminum hydroxide,

7 parts of Boracic acid,

10 parts of Ethanol,

1 part of Glass fiber, and

1.5 parts of BYK 904S.

A precursor of the fireproof composition was fabricated through dispersion, and then 4.5 parts of toluene sulfonic acid mixed therewith uniformly and then applied to the surface of a fireproof rolling curtain. The fireproof composition was dried and coagulated, and then the fireproof rolling curtain was tested for isolation from fire and smoke. As compared with the fireproof rolling curtain in the prior art, there was an insignificant increase in temperature on the backside of the fireproof rolling curtain, the fireproof rolling curtain according to the invention isolated from fire for a long period of time, there was a less amount of smokes leaked, and the fireproof rolling curtain according to the invention showed no collapsing, thus significantly improving isolation from fire and smoke by the fireproof rolling curtain, which further demonstrated fireproofing of the fireproof composition according to the invention was demonstrated.

### Third Embodiment

The fireproof composition was fabricated experimentally with the following raw materials, and fireproofing thereof was tested:

40 parts of Poly (ethylene carbonate) resin,

30 parts of Aluminum hydroxide and red phosphorus fire retardant,

17.5 parts of Lithium isinglass,

2.8 parts of Carbon fiber,

7 parts of Water, and

0.7 part of BYK 104S.

A precursor of the fireproof composition was fabricated through dispersion, and then 2 parts of Phenol sulfonic acid was added thereto and mixed therewith uniformly and then mixed with EPS foam granules with a volume-weight of 20 kg/m³, a proportion by weight of the fireproof composition to the EPS foam granules being 32:10. The fireproof composition and the foam granules are mixed in a blender, fluidized and dried at normal temperature, and finally vapor-pressurized at 0.6 MPa in an automatic forming machine into an EPS heat-preservation board. The heat-preservation board was burned in an experiment: there were no poisonous black smokes emitted, no droplets and no significant flames, and there was only slight structural shrinking of the heat-preservation board. Fireproofing of the EPS board was also significantly improved than the EPS board in the prior art up to B1-level fireproofing. Fireproofing of the fireproof composition according to the invention was demonstrated.

### Fourth Embodiment

The fireproof composition was fabricated experimentally of the following raw materials, and fireproofing thereof was tested:

60 parts of A-stage Phenolic resin,

18 parts of Aluminum hydroxide,

8.5 parts of Boracic acid,

6 parts of Methanol,

1.7 parts of Glass fiber, and

0.5 part of BYK 904S.

A precursor of the fireproof composition was fabricated through dispersion, and then 4 parts of toluene sulfonic acid was added thereto and mixed therewith uniformly to coat foam granules in an Extrudable Poly-Styrene board (an XPS board). The XPS board coated with the fireproof composition was burned in an experiment and showed good fireproofing: there were no poisonous black smokes emitted, no collapsing at high temperature and no droplets. Fireproofing of the EPS board was significantly improved than the EPS board in the prior art up to B1-level fireproofing. Fireproofing of the fireproof composition according to the invention was demonstrated.

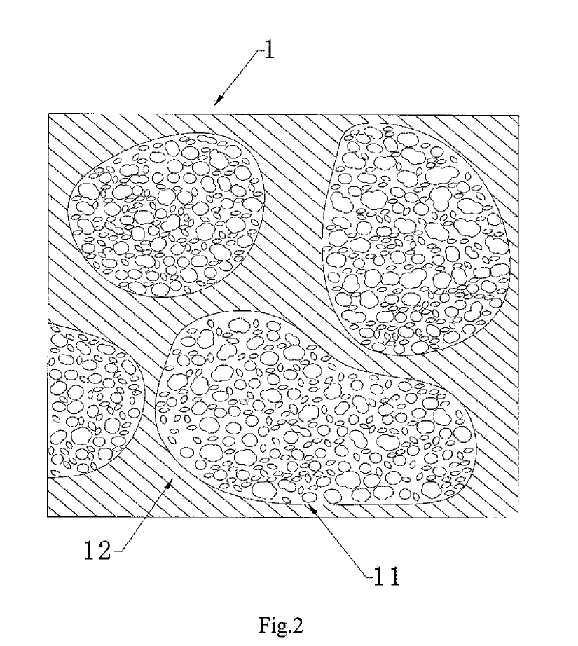

Moreover as illustrated in FIG. 1 and FIG. 2, an embodiment of the invention further provides a fireproof heat-preservation board 1 including foam plastic granules 11, and a fireproof coating 12 for bonding the foam plastic granules, and the fireproof coating 12 is the fireproof composition according to any one of the embodiments above.

The fireproof coating in the fireproof heat-preservation board 1 according to the embodiment of the invention is fabricated by adding an inorganic fire retardant to an organic thermosetting resin, and when the composition takes fire, the thermosetting resin therein is heated and cured, the structure of the heat-preservation board is maintained without collapsing in structure, and the inorganic fire retardant therein is non-combustible for the purpose of fireproofing; and also with the fire retarding structure enhancer added thereto, the resin, the inorganic fire retardant and the fire retarding structure enhancer are integrated at high temperature into the inorganic glass structural fire retardant to isolate flames and heat for the purpose of fireproofing, so that the organic foam plastic granules are non-combustible and will not emit poisonous black smokes, thus satisfying required heat preservation and fireproofing for the heat-preservation board.

In this embodiment, preferably as illustrated in FIG. 2, the fireproof coating 12 is arranged consecutively in the fireproof heat-preservation board 1, and the foam plastic granules 11 are dispersed in the fireproof heat-preservation board 1.

In this technical solution, the fireproof heat-preservation board 1 includes the dispersed foam plastic granules 11 which serve as a framework, and the consecutive fireproof coating 12 for protecting to wrap and connect together the foam plastic granules 11 to thereby effectively prevent flames from a contact with the foam plastic granules 11, so that the foam plastic granules 11 are not easily be burned, so the foam plastic granules 11 which serve as a framework will not collapse, and a much less amount of poisonous smokes will be emitted.

Preferably the volume-weight of the foam plastic granules ranges from 10 to 25 kg/m³, and the weight proportion of the foam plastic granules 11 to the fireproof coating 12 is: the foam plastic granules to the fireproof coating=1: (0.8 to 5).

If the foam plastic granules have the volume-weight in this embodiment and the weight proportion to the fireproof coating in this embodiment, then the least amount of materials will be consumed while achieving a good fireproofing effect.

In the embodiment above, preferably the foam plastic granules 11 include Polystyrene, Polyethylene, Polypropylene, Polyurethane or Polyvinylchloride granules. The foam plastic granules are embodied as Polystyrene, Polyethylene, Polypropylene, Polyurethane or Polyvinylchloride granules because their costs are low and easily available and all of these materials are characterized by low weights and a good heat preservation effect.

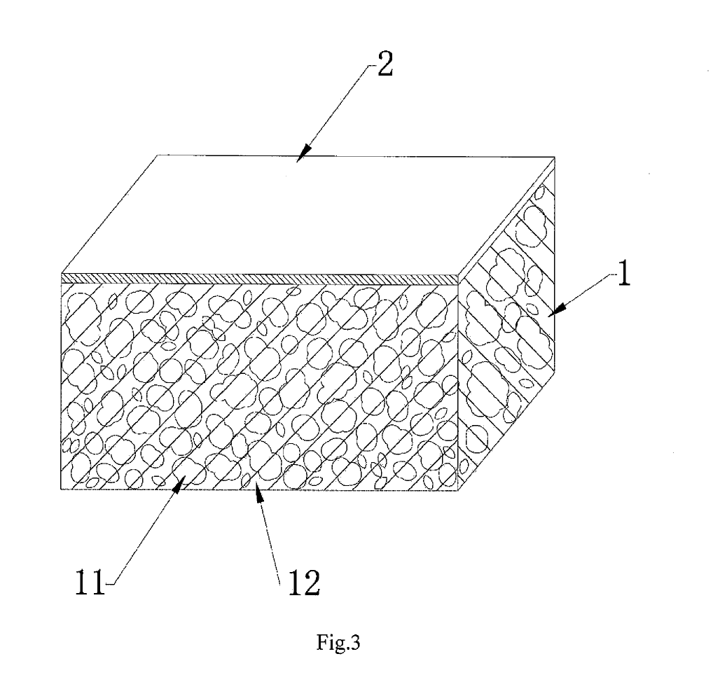

In the technical solution above, preferably as illustrated in FIG. 3, a top plate 2 is compounded on one board surface of the fireproof heat-preservation board. The fireproof heat-preservation board was tested and demonstrated A-level fireproofing. The compounded top plate 2 can improve the fireproofing and the strength of the fireproof heat-preservation board, and the top plate can be applied, carved, etc., for beautification to thereby make the heat-preservation board more appealing in appearance.

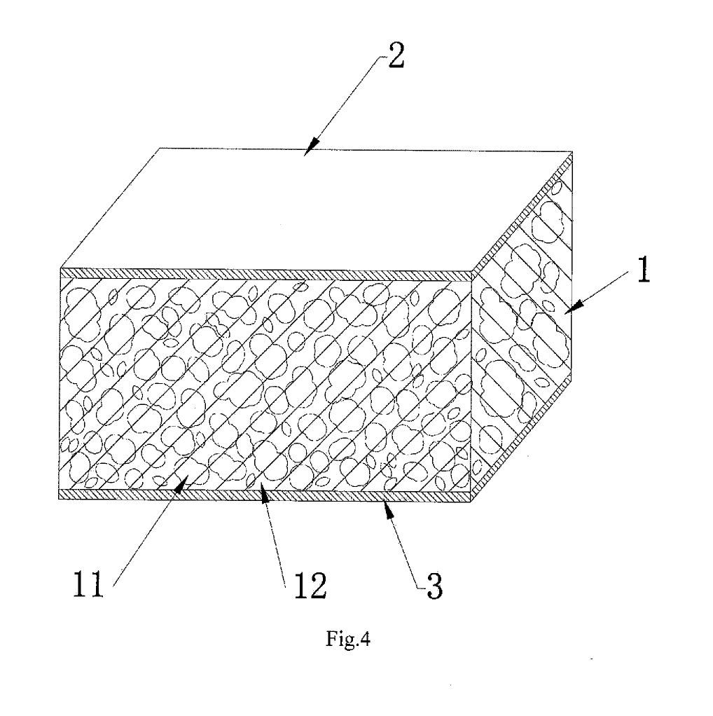

In the embodiment above, preferably as illustrated in FIG. 4, a bottom plate 3 is compounded on another board surface of the heat-preservation board. The fireproof heat-preservation board was tested and demonstrated A-level fireproofing. The compounded bottom plate 3 can further improve the fireproofing and the strength of the fireproof heat-preservation board 1 and also facilitate installation of the fireproof heat-preservation board.

In the embodiment above, preferably the top plate 2 and/or the bottom plate 3 are compounded through adhesives easily and at a low cost.

In the embodiment above, preferably the top plate 2 is a color steel plate, a Calcium silicate plate, a cement fiber plate, an aluminum foil, a fiber cement cloth or a stone plate; and the bottom plate 3 is also a color steel plate, a Calcium silicate plate, a cement fiber plate, an aluminum foil, a fiber cement cloth or a stone plate. These plate materials are easily available and have high strength and low weights and thus can be satisfactory to outdoor walls in use.

In summary, the fireproof heat-preservation board above according to the embodiment of the invention includes the dispersed foam plastic granules which serve as a framework, and the consecutive fireproof coating for protecting, to thereby effectively prevent burning and collapsing at high temperature and greatly suppress poisonous smokes from being emitted. The fireproof composition which is used as the fireproof coating in the fireproof heat-preservation board according to the embodiment of the invention includes the organic thermosetting resin and the inorganic fire retardant added thereto, and when the composition takes fire, the thermosetting resin therein is heated and cured, the structure of the heat-preservation board is maintained without collapsing in structure, and the inorganic fire retardant is non-combustible for the purpose of fireproofing. Also with the fire retarding structure enhancer added thereto, the resin, the inorganic fire retardant and the fire retarding structure enhancer are integrated at high temperature into the inorganic glass structural fire retardant to isolate flames and heat for the purpose of fireproofing; and moreover the organic foam plastic granules are not burned and will not emit poisonous black smokes. Moreover the reinforcing fibers can be further added as desirable to thereby improve the strength of the fireproof coating and further the strength of the fireproof heat-preservation board, facilitate installation thereof and further enable the component not to collapse at high temperature, so as to address the numerous drawbacks of the existing heat-preservation boards of buildings and satisfy the required level and heat preservation for the heat-preservation boards of buildings. Moreover the top plate and/or the bottom plate can be further compounded on the fireproof heat-preservation board to thereby further improve the fireproofing and the strength of the fireproof heat-preservation board.

The foregoing disclosure is merely illustrative of the preferred embodiments of the invention but not intended to limit the invention, and those skilled in the art can make various modifications and variations to the invention. Any modifications, equivalent substitutions, adaptations, etc., made without departing from the spirit of the invention shall fall into the scope of the invention as claimed in the appended claims.

1. A fireproof composition, comprising the following components:
30 to 65 parts by weight of a thermosetting resin;
15 to 45 parts by weight of an inorganic fire-retardant;
2 to 25 parts by weight of a fire retarding structure enhancer;
5 to 15 parts by weight of a solvent; and
2 to 6 parts by weight of a curing agent,
wherein the curing agent is packaged separately for adding in use.

2. The fireproof composition according to claim 1, further comprising: 1 to 5 parts by weight of reinforcing fiber.

3. The fireproof composition according to claim 2, further comprising: 0.2 to 2.0 parts by weight of a dispersant and a surfactant.

4. The fireproof composition according to claim 1, wherein the thermosetting resin comprises a Polyacrylic acid resin, a Poly (ethylene carbonate) resin, a Polyurethane resin, a Polyvinyl acetate resin or a Phenolic resin.

5. The fireproof composition according to claim 4, wherein the Phenolic resin is an A-stage Phenolic resin as a result of condensation reaction between phenol and Paraformaldehyde under an alkali catalyst, wherein the phenol, the Paraformaldehyde and the alkali catalyst are proportioned as 40 to 60 parts by weight of the phenol, 30 to 45 parts by weight of the Paraformaldehyde, and 1.5 to 8.0 parts by weight of the alkali catalyst together with 5 to 15 parts by weight of water, all of which react with each other for five hours at 70 to 80 □ into the A-stage Phenolic resin.

6. The fireproof composition according to claim 1, wherein the inorganic fire retardant comprises any one or combination of magnesium hydroxide, aluminum hydroxide, carbon black, red phosphorus fire-retardant and ammonium polyphosphate.

7. The fireproof composition according to claim 1, wherein the fire retarding structure enhancer comprises any one or combination of lithium carbonate, lepidolite, boracic acid and borax.

8. The fireproof composition according to claim 1, wherein the solvent is water, methanol or ethanol.

9. The fireproof composition according to claim 1, wherein the curing agent is phenol sulfonic acid or toluene sulfonic acid.

10. The fireproof composition according to claim 3, wherein the reinforcing fiber comprises any one or combination of glass fiber, carbon fiber and metal fiber.

11. The fireproof composition according to claim 3, wherein the dispersant and the surfactant comprise a mixture of modified Polysiloxane and polymeric carboxylic acid.

12. The fireproof composition according to claim 3, wherein the thermosetting resin comprises a Polyacrylic acid resin, a Poly (ethylene carbonate) resin, a Polyurethane resin, a Polyvinyl acetate resin or a Phenolic resin; the inorganic fire retardant comprises any one or combination of magnesium hydroxide, aluminum hydroxide, carbon black, red phosphorus fire-retardant and ammonium polyphosphate; the fire retarding structure enhancer comprises any one or combination of lithium carbonate, lepidolite, boracic acid and borax; the solvent is water, methanol or ethanol; the curing agent is phenol sulfonic acid or toluene sulfonic acid; the reinforcing fiber comprises any one or combination of glass fiber, carbon fiber and metal fiber; and the dispersant and the surfactant comprise a mixture of modified Polysiloxane and polymeric carboxylic acid.

13. A fireproof heat-preservation board, comprising foam plastic granules, and a fireproof coating for bonding the foam plastic granules, wherein the fireproof coating is the fireproof composition according to claim 1.

14. The fireproof heat-preservation board according to claim 13, wherein the fireproof coating is arranged consecutively in the fireproof heat-preservation board, and the foam plastic granules are dispersed in the fireproof heat-preservation board.

15. The fireproof heat-preservation board according to claim 14, wherein a volume-weight of the foam plastic granules is 10 to 25 kg/m³, and a weight proportion of the foam plastic granules to the fireproof coating is: the foam plastic granules to the fireproof coating=1: (0.8 to 5).

16. The fireproof heat-preservation board according to claim 13, wherein the foam plastic granules comprise Polystyrene, Polyethylene, Polypropylene, Polyurethane or Polyvinylchloride granules.

17. The fireproof heat-preservation board according to claim 16, wherein a top plate is compounded on one board surface of the fireproof heat-preservation board.

18. The fireproof heat-preservation board according to claim 17, wherein a bottom plate is compounded on another board surface of the heat-preservation board.

19. The fireproof heat-preservation board according to claim 18, wherein the top plate and/or the bottom plate are compounded through adhesives.

20. The fireproof heat-preservation board according to claim 19, wherein the top plate is a color steel plate, a calcium silicate plate, a cement fiber plate, an aluminum foil, a fiber cement cloth or a stone plate; and the bottom plate is a color steel plate, a calcium silicate plate, a cement fiber plate, an aluminum foil, a fiber cement cloth or a stone plate.
